(19) United States
(12) Patent Application Publication
(10) Pub. No.: US 2010/0070273 A1
(43) Pub. Date: Mar. 18, 2010

(54) SPEECH SYNTHESIS AND VOICE RECOGNITION IN METROLOGIC EQUIPMENT

(75) Inventors: Manuel I. Rodriguez, St. Petersburg, FL (US); Nicholas Lyn-Sue, Seminole, FL (US)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/212,297

(22) Filed: Sep. 17, 2008

(51) Int. Cl. G10L 15/00; G10L 13/00

(52) U.S. Cl. 704/231; 704/258; 704/E15.001

(57) ABSTRACT

An electronic test equipment apparatus is provided. A metrologic device is adapted for creating stimulus signals and capturing responses from electronic devices under test (DUTs). An auditory device is in communication with the metrologic device. The auditory device is adapted for converting an output of the metrologic device to an audio signal to be heard by a user.

### FIELD OF THE INVENTION

The present invention generally relates to electronics devices, and more particularly, but not exclusively, to speech synthesis and voice recognition devices integrated into, or otherwise associated with, metrologic equipment.

### BACKGROUND OF THE INVENTION

Metrologic equipment includes a number of devices used to analyze and test electronic components in electronics devices. For example, metrologic equipment may include voltmeters to measure a voltage across two nodes, an oscilloscope to measure a waveform, an ammeter to measure current, etc. Users of metrologic equipment perform test procedures to diagnose equipment problems, perform research and development functions, and perform a variety of additional tasks.

The use of metrologic equipment in laboratory environments often requires the operator to change focus from the unit or component being measured (i.e. circuit assembly) to the metrologic equipment repeatedly, therefore reducing efficiency and increasing the probability of error.

For example, test points in electronics devices are often very small, requiring a lot of precision so as not to short or damage components. As a result, an engineer measuring an attribute of the electronics device, such as a voltage on a circuit board, has to locate the test point, connect the probe to the test point, and then switch focus by looking at the readout of the voltmeter and/or change the settings of the metrologic equipment. The engineer may have to repeat these steps, constantly switching focus between the voltmeter and the circuit board.

### BRIEF SUMMARY OF THE INVENTION

In light of the foregoing, a need exists for a mechanism by which a user of metrologic equipment, such as an engineer in a laboratory setting, may perform tasks without the requirement of physically looking at a display, manually changing settings on the metrologic equipment, and allowing the user to focus on the electronics device, component, circuit, etc. under analysis.

Accordingly, in one embodiment, by way of example only, an electronic test equipment apparatus is provided. A metrologic device is adapted for creating stimulus signals and capturing responses from electronic devices under test (DUTs). An auditory device is in communication with the metrologic device. The auditory device is adapted for converting an output of the metrologic device to an audio signal to be heard by a user.

In another embodiment, again by way of example only, a method for analyzing electronic devices under test (DUTs) is provided. At least one of creating stimulus signals for and capturing responses from the electronic devices is performed using a metrologic device. An output of the metrologic device is converted to an audio signal to be heard by a user.

In still another embodiment, again by way of example only, a computer program product for analyzing electronic devices under test (DUTs) is provided. The computer program product comprises a computer-readable storage medium having computer-readable program code portions stored therein. The computer-readable program code portions comprise a first executable portion for performing at least one of creating stimulus signals for and capturing responses from the electronic devices using a metrologic device, and a second executable portion for converting an output of the metrologic device to an audio signal to be heard by a user.

### BRIEF DESCRIPTION OF THE DRAWINGS

The present invention will hereinafter be described in conjunction with the following drawing figures, wherein like numerals denote like elements, and

FIG. 1 illustrates an exemplary multimeter embodiment of electronic test equipment;

FIG. 2 illustrates a block diagram of exemplary functionality of the multimeter embodiment of FIG. 1;

FIG. 3 illustrates a block diagram of an additional embodiment of electronic test equipment; and

FIG. 4 illustrates an exemplary method for analyzing electronics devices under test (DUTs).

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present description and following claimed subject matter present exemplary embodiments of electronics test equipment having integrated voice synthesis and voice recognition functionality. The illustrated embodiments allow a user to maintain their focus on the test point, while listening to and/or commanding the electronics test equipment. In some embodiments, wireless communication functionality may be integrated into the electronics test equipment. This allows a user, for example, to wear a wireless headset to allow for greater flexibility.

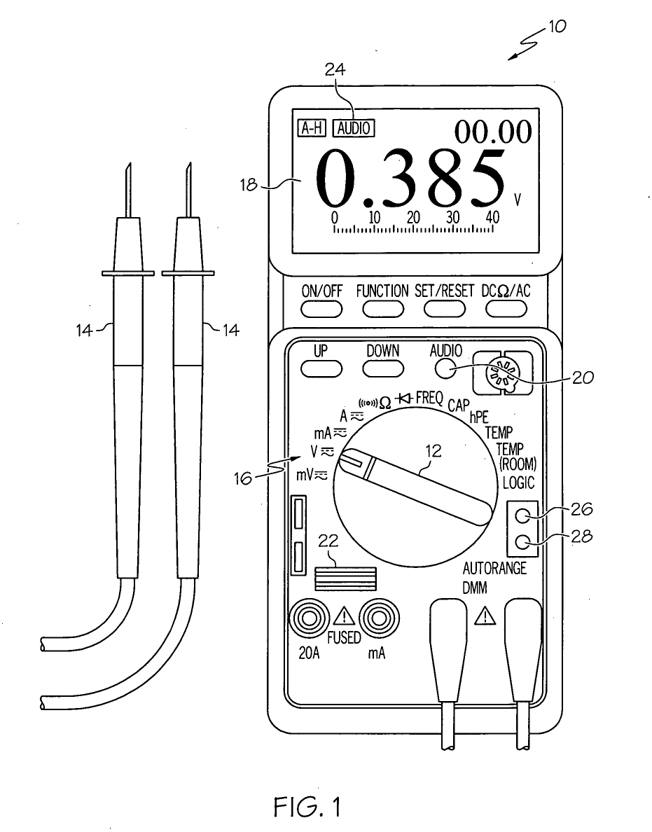

Turning to FIG. 1, exemplary electronics test equipment embodied in a multimeter 10 is illustrated. Multimeter 10 allows, as one skilled in the art will appreciate, the collection of a variety of electronics data, such as voltage, current, capacitance, frequency, field strength, and temperature. The electronics data is obtained using selector knob 12 to select the desired function, and using the probes 14 which are placed at test points on the electronics devices under test.

In the illustrated embodiment, selector knob 12 is positioned to select the voltmeter function (V) 16. Multimeter 10 is configured to allow for the measurement of direct current (DC) and alternating current (AC) volts using a single selector position 16. Display 18 shows an example output measurement of 0.385V.

Multimeter 10 includes an audio selector button 20. Audio button 20 enables audio functionality on multimeter 10. When audio button selector 20 is depressed, audio indicator 24 is shown in display 18 as seen to signify that the audio functionality has been enabled. A user may depress audio selector button 20 to enable the conversion of the digital output measurement of 0.385V to an audio signal fed to speaker 22. As a result, when the user connects the probes 14 to the test point and the audio selector functionality is enabled, voice synthesis functionality integrated into the multimeter 10 produces a voice output of “0.385 Volts” through mic/speaker 22, or through headphone jack 26.

Audio functionality integrated into multimeter 10 also includes voice recognition functionality. A user may plug an external microphone into microphone jack 28. In other embodiments, the skilled artisan will appreciate that headphone jack 26 and microphone jack 28 are integrated into a single jack adapted to connect to a headset. In other embodiments, multimeter 10 may be equipped with wireless functionality to allow a user to wear a wireless headset to receive voice synthesized output measurements and provide voice commands.

A user may speak a voice command into the mic/speaker 22 or into a microphone integrated into a headset connected to the multimeter 10. For example, the user may say “select volts” to cause the multimeter 10 to choose the voltmeter function 16. The voice recognition functionality integrated into multimeter 10 allows for the conversion of a recognized voice command to a machine instruction. The voice synthesis and voice recognition functionality will be further described, following.

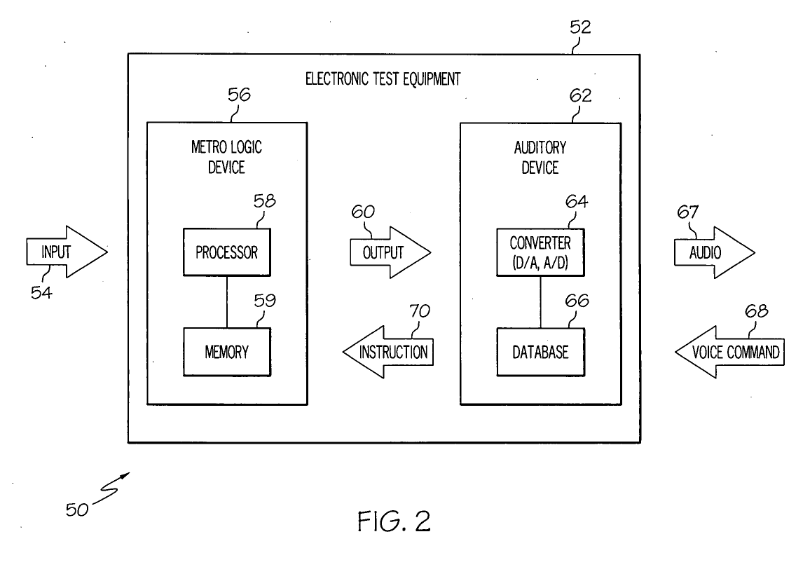

Turning to FIG. 2, a block diagram of exemplary voice synthesis and voice recognition functionality 50 for electronic test equipment 52 is depicted. Electronic test equipment 52 may include a variety of equipment, such as a voltmeter, an ohmmeter, an ammeter, a multimeter, a power supply, a signal generator, a pattern generator, a pulse generator, an oscilloscope, a frequency counter, a test probe, a solenoid voltmeter, a clamp meter, a wheatstone bridge, a capacitance meter, an LCR meter, an EMF meter, an electrometer, a signal tracer, a logic analyzer, a spectrum analyzer, a vector signal analyzer, a time-domain reflectometer, and a signal generator. Electronic test equipment 52 may, as the skilled artisan will appreciate, encompass additional electronics devices, such as medical devices. For example, electronic test equipment 52 may include sensor devices placed in communication with mechanical or electrical hardware and/or systems, such as a vehicle.

A metrologic device 56 is integrated into the equipment 52. The metrologic device performs the functionality of sending test signals and/or receiving measurement data from the electronic devices under test. In the case of a voltmeter, for example, the metrologic device 56 includes the components necessary to perform the voltmeter functionality, such as a processor 58 in communication with a memory 59. As the skilled artisan will appreciate, the metrologic device 56 may include additional components, or the components may vary in a particular implementation. For example, in the case of medical electronic test equipment 52, the metrologic device 56 may include a heart rate sensor/monitor or a pulse oximeter.

Metrologic device 56 provides an output 60, such as a voltage measurement. The output 60 is provided to an auditory device 62. Auditory device 62 includes one or more converters and additional processors 64. For example, the converters/processors 64 may include various digital-to-analog (D/A) and/or analog-to-digital (A/D) converters for converting analog signals to/from digital signals. In one embodiment, auditory device 62 also leverages the processing power of processor 58 to perform conversion functions.

Converters/processors 64 are connected to a database 66. Database 66 may store a list of recognized voice commands, for example. These commands may include such commands as “select,” and “volts.” The skilled artisan will appreciate that a variety of commands may be delineated in a particular implementation.

Output 60 is processed through the auditory device to provide an audio signal 66. The audio signal may be a voice synthesized conversion of the digital measurement, for example. In other embodiments, the audio signal may be an audio tone that changes in pitch as the measurement is increased/decreased. For example, the audio tone may increase in pitch as a particular voltage measurement increases, and decrease in pitch as a voltage measurement decreases.

A user may speak a voice command 68 that is input to the auditory device 62 for conversion to a machine instruction 70. The machine instruction is then provided to the metrologic device 56 to perform a specific function. Per the foregoing example, the voice command “select volts” may be converted to the machine instruction for the metrologic device to select voltmeter functionality. In a further example using an oscilloscope as metrologic device 56, the user may use the voice command “increase time base” or “zoom out” to broaden the oscilloscope's time base by a predetermined amount.

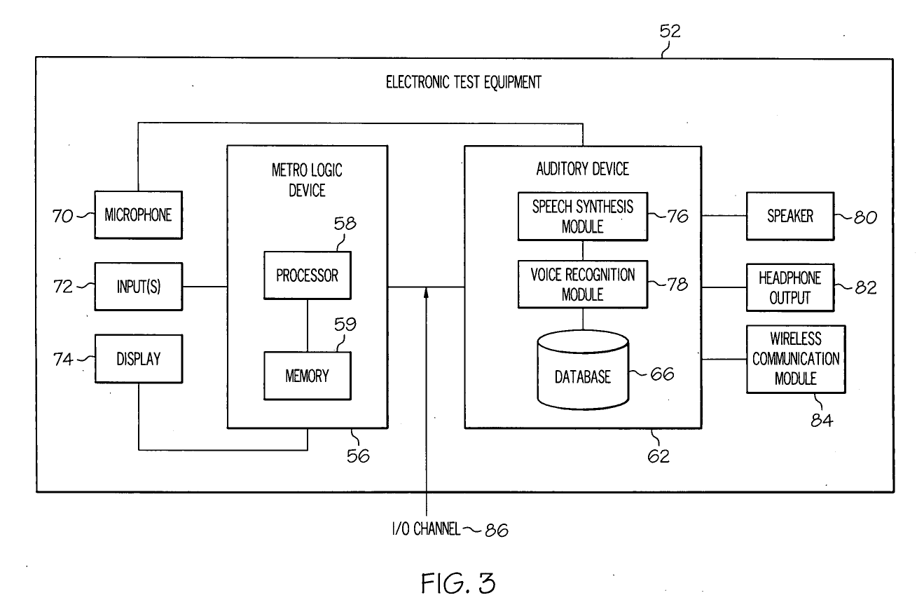

Turning to FIG. 3, an additional block diagram of electronic test equipment 52 is illustrated. Equipment 52 includes a microphone 70, one or more inputs (such as inputs adapted to connect to probes 14 (FIG. 1), and a display 74. Inputs 72 are provided to the metrologic device 56. Metrologic device 56 also provides an output connected to the display.

Microphone 70 is connected to the auditory device 62. Auditory device 62 includes a speech synthesis module in communication with a voice recognition module 78 and database 66. Auditory device provides audio signals output to speaker 80, headphone output 82, and to the wireless communication module 84.

Auditory device 62 is connected to metrologic device 56 through an input/output (I/O) channel 86. For example, a digital output measurement is passed through I/O channel 86 to the auditory device 62 as an input. A voice command that has been converted to a machine instruction is passed through I/O channel 86 to metrologic device 56 as an input.

Wireless communication module 84 provides wireless communication functionality for the equipment 52 according to an available variety of wireless communications schemes. In one embodiment, wireless communication module 84 is compliant with the 2.4 GHz short-range radio frequency bandwidth commonly known as Bluetooth®. In other embodiments, wireless communication module 84 may implement other wireless communications schemes as the skilled artisan will appreciate.

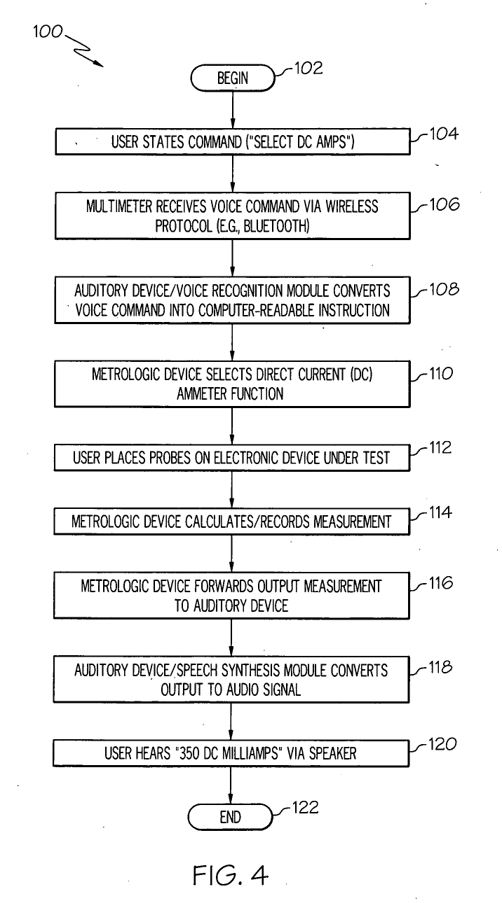

Turning to FIG. 4, an exemplary method 100 for analyzing an electronics device using electronics test equipment, such as a multimeter, is depicted. As one skilled in the art will appreciate, various steps in the method 100 may be implemented in differing ways to suit a particular application. In addition, the described method 100 may be implemented by various means, such as hardware, software, firmware, or a combination thereof operational on or otherwise associated with the blade server environment. For example, the method 100 may be implemented, partially or wholly, as a computer program product including a computer-readable storage medium having computer-readable program code portions stored therein. The computer-readable storage medium may include disk drives, flash memory, digital versatile disks (DVDs), compact disks (CDs), and other types of storage mediums.

Method 100 begins (step 102) with a user stating a command, such as “select DC Amps” (step 104). The voice command is received by the multimeter via a wireless protocol (step 106). The auditory device/voice recognition module converts the voice command into a computer-readable machine instruction (step 108).

Control then moves to step 110, where the metrologic device, in response to receiving the machine instruction, selects the DC ammeter functionality. The user places probes on the electronic device under test (step 112). The metrologic device calculates and/or records the measurement (step 114). The output measurement is then forwarded to the auditory device (step 116).

The auditory device utilizes the speech synthesis module to convert the output measurement to an audio signal (step 118). The audio signal is transferred to the user either again via the wireless protocol or fed to an onboard speaker. The user hears the output measurement, such as “350 DC milliamps” (step 120). The method 100 then ends (step 122).

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are described to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Some of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices and processors. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While one or more embodiments of the present invention have been illustrated in detail, the skilled artisan will appreciate that modifications and adaptations to those embodiments may be made without departing from the scope of the present invention as set forth in the following claims.

What is claimed is:

1. An electronic test equipment apparatus, comprising:
a metrologic device adapted for creating stimulus signals and capturing responses from electronic devices under test (DUTs); and
an auditory device in communication with the metrologic device, wherein the auditory device is adapted for converting an output of the metrologic device to an audio signal to be heard by a user.

2. The apparatus of claim 1, wherein the auditory device includes a speech synthesis module adapted for converting the output of the metrologic device into speech representative of an attribute of the output.

3. The apparatus of claim 1, wherein the audio signal includes at least one audio tone representative of an attribute of the output.

4. The apparatus of claim 1, wherein the auditory device includes a voice recognition module adapted for converting a voice input received from a user into an electronic instruction of the metrologic device.

5. The apparatus of claim 1, further including a wireless module in communication with the auditory device, wherein the wireless module is adapted for performing at least one of receiving an audio input and transmitting the audio signal via a wireless communications protocol.

6. The apparatus of claim 5, further including a wireless headset adapted to connect to the wireless module via the wireless communications protocol.

7. The apparatus of claim 1 wherein the metrologic device includes one of a voltmeter, an ohmmeter, an ammeter, a multimeter, a power supply, a signal generator, a pattern generator, a pulse generator, an oscilloscope, a frequency counter, a test probe, a solenoid voltmeter, a clamp meter, a wheatstone bridge, a capacitance meter, an LCR meter, an EMF meter, an electrometer, a signal tracer, a logic analyzer, a spectrum analyzer, a vector signal analyzer, a time-domain reflectometer, and a signal generator.

8. A method for analyzing electronic devices under test (DUTs), comprising:
performing at least one of creating stimulus signals for and capturing responses from the electronic devices using a metrologic device; and
converting an output of the metrologic device to an audio signal to be heard by a user.

9. The method of claim 8, wherein converting the output of the metrologic device to the audio signal to be heard by the user includes converting the output of the metrologic device into speech representative of an attribute of the output.

10. The method of claim 8, wherein converting the output of the metrologic device to the audio signal to be heard by the user includes converting the output of the metrologic device into at least one audio tone representative of an attribute of the output.

11. The method of claim 8, further including converting a voice input received from the user into an electronic instruction of the metrologic device.

12. The method of claim 8, further including performing at least one of receiving an audio input from the user and transmitting the audio signal to the user via a wireless communications protocol.

13. The method of claim 12, wherein the performing the at least one of receiving the audio input from the user and transmitting the audio signal to the user occurs using a wireless headset adapted to connect to the wireless module via the wireless communications protocol.

14. The method of claim 8 wherein performing the at least one of creating stimulus signals for and capturing responses from the electronic devices using the metrologic device includes performing the at least one of creating stimulus signals for and capturing responses from the electronic devices using one of a voltmeter, an ohmmeter, an ammeter, a multimeter, a power supply, a signal generator, a pattern generator, a pulse generator, an oscilloscope, a frequency counter, a test probe, a solenoid voltmeter, a clamp meter, a wheatstone bridge, a capacitance meter, an LCR meter, an EMF meter, an electrometer, a signal tracer, a logic analyzer, a spectrum analyzer, a vector signal analyzer, a time-domain reflectometer, and a signal generator.

15. A computer program product for analyzing electronic devices under test (DUTs), the computer program product comprising a computer-readable storage medium having computer-readable program code portions stored therein, the computer-readable program code portions comprising:
a first executable portion for performing at least one of creating stimulus signals for and capturing responses from the electronic devices using a metrologic device; and
a second executable portion for converting an output of the metrologic device to an audio signal to be heard by a user.

16. The computer program product of claim 15, further including a third executable portion for converting the output of the metrologic device into speech representative of an attribute of the output.

17. The computer program product of claim 15, further including a third executable portion for converting the output of the metrologic device into at least one audio tone representative of an attribute of the output.

18. The computer program product of claim 15, further including a third executable portion for converting a voice input received from the user into an electronic instruction of the metrologic device.

19. The computer program product of claim 15, further including a third executable portion for performing at least one of receiving an audio input from the user and transmitting the audio signal to the user via a wireless communications protocol.

20. The computer program product of claim 15 wherein the metrologic device includes one of a voltmeter, an ohmmeter, an ammeter, a multimeter, a power supply, a signal generator, a pattern generator, a pulse generator, an oscilloscope, a frequency counter, a test probe, a solenoid voltmeter, a clamp meter, a wheatstone bridge, a capacitance meter, an LCR meter, an EMF meter, an electrometer, a signal tracer, a logic analyzer, a spectrum analyzer, a vector signal analyzer, a time-domain reflectometer, and a signal generator.
